(19) United States
(12) Patent Application Publication
(10) Pub. No.: US 2006/0136501 A1
(43) Pub. Date: Jun. 22, 2006

(54) Method and apparatus for saving and restoring parameter values set with user commands

(75) Inventors: Shaun Ijeomah, Poughkeepsie, NY (US); Karelene G. Powell, Poughkeepsie, NY (US)

Correspondence Address: William A. Kinnaman, Jr.;IBM Corporation - MS P 386, 2455 South Road, Poughkeepsie, NY, 12601, US

(73) Assignee: International Business Machines Corporation, Armonk, NY (US)

(21) Appl. No.: 11/018,887

(22) Filed: Dec. 21, 2004

(51) Int. Cl. G06F 17/30

(52) U.S. Cl. 707/200

(57) ABSTRACT

A method and apparatus for changing an attribute such as the owner or mode of a file system object such as a file or directory in an information handling system. In response to receiving a user command to change the value of the attribute to a new value, the existing value of the attribute is saved and the value of the attribute is then changed to the new value. The user may later use the saved value to restore the value of the attribute to a previous value. The existing value is saved in a temporary directory allocated to the user, from which it is deleted upon the lapse of a predetermined time period. The time period is settable by the user or set to a default value if it is not set by the user. The user may specify a subset of file system objects whose attributes are saved.

### BACKGROUND OF THE INVENTION

1. Field of the Invention

This invention relates to a method and apparatus for saving and restoring parameter values set with user commands, especially UNIX commands such as chmod, chown and the like.

2. Description of the Related Art

As is well known in the art of information handling systems, operating systems are software programs that manage the use of system resources by competing users and tasks, perform basic system services, and the like. Although the present invention is not limited to any particular operating system, well-known examples of operating systems include versions of the Microsoft Windows™ operating system and variants of the UNIX™ operating system, whether or not derived from a UNIX code base or branded as UNIX systems. (Windows is a trademark of Microsoft Corporation; UNIX is a trademark of The Open Group.) Such variants include the Linux™ and IBM AIX™ operating systems and the UNIX System Services component of the IBM Z/OS™ operating system. (Linux is a trademark of Linus Torvalds; AIX and z/OS are trademarks of IBM Corporation.) Among the resources managed by an operating system is the file system, typically a hierarchical file system (HFS) in which files are organized into directories forming a tree structure off a root directory.

Files and directories have certain attributes that determine how they are used by the various entities in a computer system. Thus, in a UNIX system, each file or directory is associated with an owner as well as a group to which the owner belongs. Each such UNIX file or directory also has three sets of permission bits, which determine how the file or directory may be used by the owner, by others in the owner's group, and by all others, respectively. Other attributes may also be defined for a file or directory, such as the extended attributes described below.

When a file or directory is created, its attributes are determined either expressly or by default. Such attributes may also be subsequently changed through the use of user commands inputted to a command shell of the operating system. Examples from the UNIX operating system include the chmod command for changing the permission bits and extended attributes of a file or directory and the chown command for changing the owner or group of a file or directory. In UNIX and other operating systems, such commands allow users to manipulate information pertaining to files, system setup, users and groups. In short, user commands allow a user to navigate within the operating system environment. As a particular example, commands for the UNIX System Services component of the IBM z/OS operating system are described in the IBM publication z/OS UNIX System Services Command Reference, SA22-7802-04, incorporated herein by reference.

In such systems, once an attribute of a file or directory has been changed, there is no current method that conveniently allows a user to restore the previous attributes of that file or directory. The only way the user can restore previous attributes of the file or directory is either to remember the previous attributes or to recreate the file or directory, providing its attributes have not been changed after its original creation.

Currently available in UNIX is the filecache command. This command allows a superuser to manage cached files for read-only. This command can only be invoked by a superuser to manage files pertaining to data files, message catalog files, scripts, and executable programs. Furthermore, this command does not allow caching of any recently modified files until the file system in which the files reside is unmounted and then remounted or until the system is restarted.

### SUMMARY OF THE INVENTION

The present invention contemplates a method and apparatus for changing an attribute of a target file system object in an information handling system. The target object may be a file, a directory, or even the file system itself. The attribute may be a set of permissions defined for the target object or the owner or group associated with the target object, among other possibilities. In accordance with the invention, in response to receiving a command from a user to change the value of the attribute to a new value, the existing value of the attribute is saved and the value of the attribute is then changed to the new value. The user may later use the saved value to restore the value of the attribute to a previous value.

In a preferred embodiment, the existing value may be saved in a temporary directory allocated to the user and may be deleted upon the lapse of a predetermined time period after being saved. In such embodiment, the predetermined time period may be settable by the user or may be set to a default value if it is not set by the user.

The saving of attribute values may be enabled for all such objects (i.e., all files and directories) or may be enabled for only a subset of such objects (e.g., all files or all directories).

The present invention allows a user to restore characteristics of a file, directory or file system without having to restart the system or unmount or remount the file system. As such, it builds upon the current POSIX standard and constitutes an extension of that standard.

The present invention allows any user to cache and manage attributes such as file types and permissions of the applicable file or directory. Unlike the filecache command, the present invention allows any user, superuser or file or directory owner to restore the parameters for a file or directory regardless of the permission setting. In addition, the invention allows the file or directory parameters to be dynamically restored without respect to the creation time and does not require a restart of the system or unmount and remount of the file system to update changes.

### BRIEF DESCRIPTION OF THE DRAWINGS

FIG. 1 shows a computer system incorporating the present invention.

FIG. 2 shows a typical file system of the computer system shown in FIG. 1.

FIG. 3 shows the general procedure of the present invention for saving one or more parameter values.

FIG. 4 shows the general procedure of the present invention for restoring one or more parameter values.

### DESCRIPTION OF THE PREFERRED EMBODIMENTS

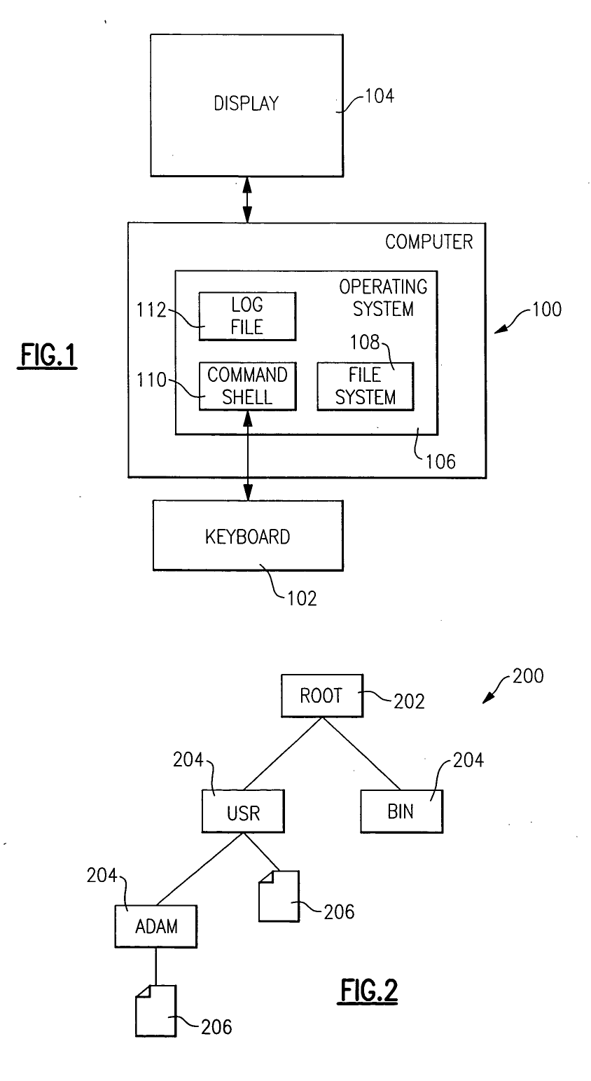

FIG. 1 shows a computer system 100 incorporating the present invention. As is well known in the art, computer system 100 contains a central processing unit (CPU), main storage such as a random-access memory (RAM), and secondary storage such as a magnetic or optical disk drive that is either contained in a common system unit or attached externally. Computer system 100 is also attached to various input/output (I/O) devices, such as the keyboard 102 and display 104 that are shown, as well as other devices such as a mouse, a printer, a network connection and the like. These various hardware elements function entirely conventionally in the present invention and therefore, except for the keyboard 102 and display 104, are not shown.

Computer system 100 also has one or more software programs running on it, including an operating system (OS) 106. OS 106 in turn contains file system 108 and a command shell 110. As noted above, OS 106 manages the use of system resources by competing users and tasks, performs basic system services, and the like. File system 108, as is conventional in the art, provides a programming infrastructure for storing and accessing the various files that are used by OS 106 and applications (not shown) running thereon. Command shell 10 provides an interface between OS 106 and the user, who may enter a command on an input device such as keyboard 102 and view the results of the command on an output device such as display 104.

Computer system 100 may be either a client system or a server system. While the present invention is not limited to any particular hardware-software platform, in a preferred embodiment computer system 100 may comprise an IBM eServer™ zSeries™ server, while OS 106 may comprise the IBM z/OS™ operating system with its UNIX System Services component. (eServer, zSeries and z/OS are trademarks of IBM.)

Referring to FIG. 2, file system 108 is preferably a hierarchical file system (HFS) 200 with a root directory 202, various subdirectories 204, and files 206. As shown, each directory, including the root directory 202 as well as the subdirectories 204, may contain one or more subdirectories 204 as well as one or more files 206.

In the embodiment shown, the cache option (as the option to log attribute changes is referred to herein) can be set to record file and directory changes to the entire file system 200 for a specified window of time. When the cache option is enabled and a user enters a command to change the attributes or characteristics of a file 206 or directory 204, a “snapshot” is taken of the current state of the file 206 or directory 204 prior to the completion of the command. That current state is then saved in a special log file 112 (FIG. 1) called cachelog in the embodiment shown, although the name of the log file is irrelevant to the working of the invention. Any subsequent changes to the file 206 or directory 204 are logged and tagged with the date and time detailing the current state before the changes. That current state (or any other current state also recorded in the log file 112 for that file 206 or directory 204) can then be restored when needed.

File types, file permissions, and file attributes are restored by invoking a new command:
restor [+apt]filename
   In the above command, restor is the command name, a, p and t are options (introduced by the symbol “+”), and filename is the name of the target object (which may be a file or a directory). Among the options, a indicates file attributes generally, p indicates file permissions, and t indicates the file type. Although not shown above, if desired, the restor command may provide a suboption under the t option to allow users to specify which file types are to be restored if file types are being restored. Also, if desired, the restor command may provide options for restoring other special classes of attributes, such as the file owner.

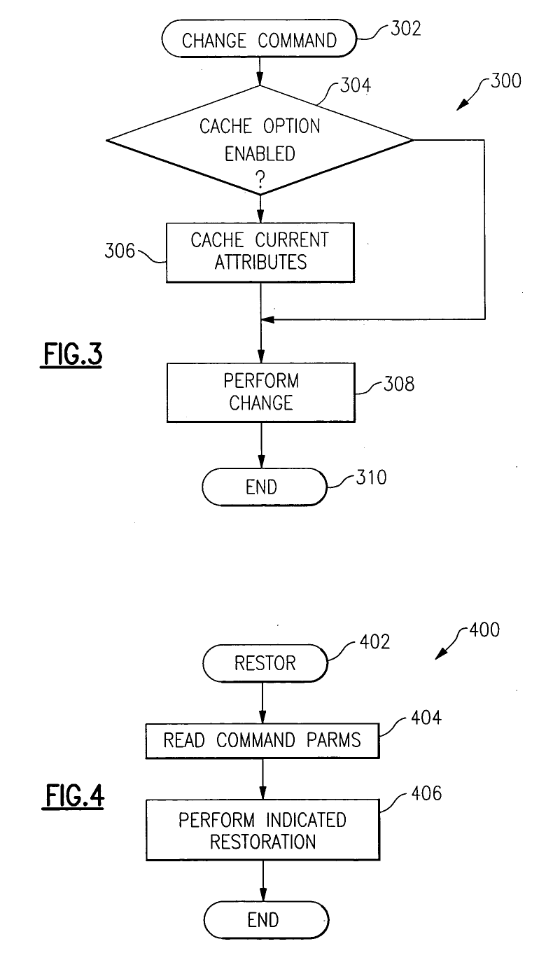

FIG. 3 shows the general procedure 300 that is followed to save one or more parameter values. The procedure 300 starts when the user enters a change command, such as chown to change the ownership of a file 206 or directory 204 or chmod to change its mode (step 302). In response to such a command, the procedure 300 first determines whether the cache option is enabled for the file system object (file 206 or directory 204) in question (step 304). If so, the procedure 300 first saves the current parameter values of the file system object in the log file 112 (step 306), then makes the requested parameter change (step 308) and returns (step 310). On the other hand, if the cache option has not been enabled for the file system object in question, then the procedure 300 makes the change without first saving the current parameter values.

FIG. 4 shows the general procedure 400 that is followed to restore one or more parameter values. The procedure is invoked when a user enters a restor command (step 402). Upon receiving such a command, the command shell 110 reads the command parameters, including the options and the name of the target object (step 404), and performs the appropriate restoration operation (step 406).

In the embodiment shown, a runtime option called FILERESTOR provides a first method by which the cache option can be invoked. Like other runtime options, this runtime option can be specified: (1) globally in the file /etc/profile, which provides a default system-wide user environment; (2) in the file .profile, which is an individual user profile residing in the user's home directory 204; or (3) from the command line. Any values in the profile file in the user's home directory 204 that differ from those in the /etc/profile file override them during the shell session. Once the cache option is invoked, file or directory parameters are sent to the log file cachelog, which starts tracking the file 206 or directory 204 beginning with its current state. The cache option tracks all file information such as file types, extended attributes, permissions, and ownership changes. The option can be invoked as follows:
export _CEE_RUNOPTS=“FILERESTOR(ON)”

In the above expression, export is the command name, and _CEE_RUNOPTS is an environment variable specifying runtime options, in this case the option FILERESTOR(ON). The effect of the command is to mark the variable name FILERESTOR so that the current shell makes it automatically available to the environment of all subsequent commands run from that shell.

A second method by which the cache option can be invoked in the embodiment shown is from the command line via a UNIX command in conjunction with a newly provided option. Thus, in the embodiment shown, the commands chmod, chown, mv and cp with the option -a turn on the cache option. A suboption cxx of the -a option (where xx indicates a two-digit number) allows the user to choose the number of days to maintain tracking information relating to the file 206 or directory 204 changed as a result of execution of the command. The following example (in which mode is the target mode) details a chmod command with an option and suboption turning on the cache option to start tracking from the time of execution for 10 days:
chmod -ac10 mode tfile

In this and similar commands, the general format is
command options arguments pathname,
   where command represents the particular command (here chmod), options represents the particular options (here -ac10), arguments represents the nonoption arguments (here mode), and pathname represents the particular file (here tfile).

When this second method is used to invoke the cache option, changes are only tracked for the particular command. Thus, if the user invokes another command such as the chown command, the user must turn on the cache option for that command as well unless the runtime option FILERESTOR is turned on using the first method above to start tracking parameter changes for all files and directories.

If the cache option is turned on via the runtime option FILERESTOR, tracking continues until the session ends or changes are made to FILERESTOR option (depending on whether the runtime option was set via the command line, etc/profile or profile). When the option is set within the user's current session, the command instruction takes effect for the attribute, file type or characteristic settings after the option is turned on. The option can be customized by the user to track changes of directories, files or both only when specifying the FILERESTOR runtime option. The table below outlines the option to indicate whether directory or file tracking should occur.

At the customization of the user, the cached information is maintained in cachelog in a temporary directory (i.e., /tmp) allocated to the user. Using the RESTORLMT runtime option described below, the user can customize how long the information is kept in the log by specifying the number of days up to a maximum of 30 days. In the embodiment shown, the log is limited to a fixed size (e.g., 4 megabytes). Once that limit is reached, the logging may wrap to the beginning of the file so that the most recent changes are retained. If the user does not specify the lifespan of the cache, the default is 7 days. At the end of the lifespan, whether determined by the default setting or by the user-specified setting, the cached data maintained is automatically deleted. The lifespan is based upon the timestamp of the directory or the file in conjunction with either the default setting or the user-specified setting. The user also has the option of turning the cache off.

Option-setting names such as the following may be used:

| | |
|---|---|
| FILERESTOR(ON) | Option to turn on the cache option. The option |
| | may contain just the argument ON or may |
| | additionally contain one of the following |
| | arguments specifying a subset of objects to be |
| | tracked: |
| | Track all directory and file changes |
| | Track directory changes only |
| | Track file changes only |
| FILERESTOR(OFF) | Option to turn off the cache option This is the |
| | default. This setting overrides any settings for |
| | RESTORLMT including the default value. |
| RESTORLMT(xx) | Option to specify the number of days, where xx |
| | is the number of days specified by the user up to |
| | a maximum number of 30 days. The installation |
| | default is 7 days. A user can specify any lesser |
| | or greater value to override the default value up |
| | to a maximum of 30. |

Turning FILERESTOR(OFF) overrides any settings for RESTORLMT including the default value.

The following is an example of invoking the FILERESTOR option to track changes for all files and directories:
export _CEE_RUNOPTS=“FILERESTOR(ON,A) RESTORLMT(xx)”

When the option is set within the user's current session, the command instruction takes effect for any parameter changes to the file or directory such as the attributes, file type, characteristic settings, and ownership. The option can be customized by the user to track changes of directories, files or both.

To view a file or directory, the user invokes (i.e., opens) the cached copy cachelog and then views the previous setting(s) of the file or directory. The log contains all instances of the file types and permission changes on the file or directory prior to the most recent change for the specified period of time. The following example contains file information indicating what type of data is contained in the log. The example contains log entries with a log cache value of 30 days.

| | | | | | | | | |
|---|---|---|---|---|---|---|---|---|
| -rw------- | --s- | 1 | IJEOMAH | DEFLT1 | 134 | Sep 13 2003 | 13:34 | toget |
| -rwxrwxrwx | --s- | 1 | IJEOMAH | DEFLT1 | 200 | Oct 10 2003 | 10:52 | toget |
| drwx------ | -p-- | 2 | IJEOMAH | DEFLT1 | 8192 | Oct 01 2003 | 15:55 | touchdir |
| drwx------ | --sl | 2 | IJEOMAH | DEFLT1 | 8192 | Oct 11 2003 | 10:00 | touchdir |

Change information is stored and displayed in a format similar to that in which file and directory information is displayed using the Is command on a Z/OS system with the -E option (for displaying extended attributes). Thus, in the above listing, the first column contains the permissions field. As is conventional in UNIX implementations, the first character of this field specifies the file type, as indicated in the following table:

| | |
|---|---|
| — | Regular file |
| b | Block special file (not supported for z/OS UNIX System Services) |
| c | Character special file |
| d | Directory |
| e | External link |
| l | Symbolic link |
| p | FIFO |
| s | Socket file type |

For files, the next three character triples indicate the read (r), write (w), and execute (x) permissions for the owner, others in the same group, and all others, respectively; a corresponding letter in this field means that the permission bit is on, while a “-” indicates that the permission bit is off (i.e., no permission). For directories, the bits in these triples indicate permission to see the list of files in the directory, permission to create and delete files in the directory, and permission to access files in the directory, respectively.

The second column in above the listing indicates the extended attributes of the file or directory, as described in the referenced IBM publication. The third column indicates the number of links to the file or directory, the fourth and fifth columns indicate the owner and group, the sixth column indicates size, the seventh and eighth columns indicate the date and time of the change, and the ninth column indicates the name of the file or directory.

Notice that the above log entries include all recent changes to directories and files.

In the embodiment shown above, the target objects are files and directories. In addition, the present invention contemplates operating on a file system as a whole as a target object. Thus, in accordance with the present invention, a superuser may be allowed to maintain similar cached information for the entire file system and to manipulate the attributes of the file system as a whole, such as “read/write” or “read only”, without an explicit unmount and remount of the file system or a restart—i.e., an initial program load (IPL)—of the system. (In executing a restor command targeting a file system, a command shell may perform an unmount followed by a remount, but this would be invisible to the superuser.)

This invention allows all restorations to occur dynamically. This invention is a time saving, user-friendly method for restoring file attributes and characteristics. In addition, it gives users more control over their individual file system.

While a particular embodiment has been shown and described, various modifications and extensions will be apparent to those skilled in the art.

What is claimed is:

1. In an information handling system having a file system containing one or more objects, a method for changing an attribute of a target object selected from among said objects, said attribute having an existing value, said method comprising the steps of:
receiving a command from a user to change the value of said attribute to a new value; and
in response to said command, saving the existing value of said attribute and changing the value of said attribute to said new value.

2. The method of claim 1 in which said existing value is saved in a temporary directory allocated to said user.

3. The method of claim 1, further comprising the step of:
deleting the saved value upon the lapse of a predetermined time period.

4. The method of claim 3 in which said predetermined time period is settable by said user.

5. The method of claim 4 in which said predetermined time period is set to a default value if it is not set by said user.

6. The method of claim 1, further comprising the step of:
specifying a subset of said objects whose attributes are saved.

7. The method of claim 6 in which said subset comprises files in said file system.

8. The method of claim 6 in which said subset comprises directories in said file system.

9. The method of claim 1 in which said command is a first command, said method further comprising the step of:
receiving a second command from a user to restore the value of said attribute to a previous value; and
in response to said second command, changing the value of said attribute to the saved value.

10. The method of claim 1 in which the target object comprises said file system.

11. The method of claim 1 in which the target object comprises a directory in said file system.

12. The method of claim 1 in which the target object comprises a file in said file system.

13. The method of claim 1 in which said attribute comprises access permissions for said target object.

14. The method of claim 1 in which said attribute comprises an owner of said target object.

15. The method of claim 1 in which said attribute comprises a group associated with said target object.

16. A program storage device readable by a machine, tangibly embodying a program of instructions executable by the machine to perform the method steps of claim 1.

17. In an information handling system having a file system containing one or more objects, apparatus for changing an attribute of a target object selected from among said objects, said attribute having an existing value, said apparatus comprising:
means for receiving a command from a user to change the value of said attribute to a new value; and
means responsive to said command for saving the existing value of said attribute and changing the value of said attribute to said new value.

18. The apparatus of claim 17, further comprising:
means for deleting the saved value upon the lapse of a predetermined time period.

19. The apparatus of claim 17, further comprising:
means for specifying a subset of said objects whose attributes are saved.

20. The apparatus of claim 1 in which said command is a first command, said apparatus further comprising:
means for receiving a second command from a user to restore the value of said attribute to a previous value; and
means response to said second command for changing the value of said attribute to the saved value.
